(19) United States
(12) Patent Application Publication
(10) Pub. No.: US 2012/0172025 A1
(43) Pub. Date: Jul. 5, 2012

(54) METHOD AND APPARATUS FOR PROVIDING RECOMMENDATIONS BASED ON PRELOADED MODELS

(75) Inventors: Pekka Hämäläinen, Kangasala As (FI); Juha Laurila, St-Legier (CH); Olivier Dousse, Lausanne (CH); Sailesh Kumar, Tampere (FI)

(73) Assignee: Nokia Corporation, Espoo (FI)

(21) Appl. No.: 12/980,812

(22) Filed: Dec. 29, 2010

(51) Int. Cl. H04W 4/00

(52) U.S. Cl. 455/419; 455/418

(57) ABSTRACT

An approach is provided for providing recommendations based on preloaded models. A recommendation model platform determines to cause, at least in part, preloading of a device with at least one user model, at least one item model, or a combination thereof. Then, the recommendation model platform determines to cause, at least in part, processing of the at least one user model, the at least one item model, or a combination thereof to generate at least one recommendation for: (a) the device, (b) at least one user of the device, or (c) a combination thereof.

### BACKGROUND

Service providers and device manufacturers (e.g., wireless, cellular, etc.) are continually challenged to deliver value and convenience to consumers by, for example, providing compelling network services. One area of interest has been configuring a device according to user's characteristics, such as user preferences and/or user behavior. Approaches have been developed to enable customization of a user device and applications in the user device according to user's preferences, by configuring settings for the user device and/or the applications. For example, users can manually customize ringing tones for different applications, alert, volumes for different operations, etc. Further, users may provide data regarding user's tendency in using the user device or the applications, such that the user device and/or the applications may be configured automatically based on the collected data. For example, a music application may maintain a record of frequencies of music files played using the music application, and may customize the music application according to the record. However, conventional approaches for personalizing the device and/or applications are often limited in scope and may need to involve external devices or services other than the device itself. Therefore, a convenient and safe way to utilize the collected data to provide automatic personalization for a device is desired.

### SOME EXAMPLE EMBODIMENTS

Therefore, there is a need for an approach for providing recommendations based on preloaded models.

According to one embodiment, a method comprises determining to cause, at least in part, preloading of a device with at least one user model, at least one item model, or a combination thereof. The method also comprises determining to cause, at least in part, processing of the at least one user model, the at least one item model, or a combination thereof to generate at least one recommendation for: (a) the device, (b) at least one user of the device, or (c) a combination thereof.

According to another embodiment, an apparatus comprises at least one processor, and at least one memory including computer program code, the at least one memory and the computer program code configured to, with the at least one processor, cause, at least in part, the apparatus to determine to cause, at least in part, preloading of a device with at least one user model, at least one item model, or a combination thereof. The apparatus also causes, at least in part, processing of the at least one user model, the at least one item model, or a combination thereof to generate at least one recommendation for: (a) the device, (b) at least one user of the device, or (c) a combination thereof.

According to another embodiment, a computer-readable storage medium carries one or more sequences of one or more instructions which, when executed by one or more processors, cause, at least in part, an apparatus to determine to cause, at least in part, preloading of a device with at least one user model, at least one item model, or a combination thereof. The apparatus also causes, at least in part, processing of the at least one user model, the at least one item model, or a combination thereof to generate at least one recommendation for: (a) the device, (b) at least one user of the device, or (c) a combination thereof.

According to another embodiment, an apparatus comprises means for determining to cause, at least in part, preloading of a device with at least one user model, at least one item model, or a combination thereof. The apparatus also comprises means for determining to cause, at least in part, processing of the at least one user model, the at least one item model, or a combination thereof to generate at least one recommendation for: (a) the device, (b) at least one user of the device, or (c) a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: an apparatus comprising means for performing the method of any of originally filed claims 1-11, 21-31, and 48-51.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing recommendations based on preloaded models, according to one embodiment;

FIG. 2 is a diagram of the components of the model platform, according to one embodiment;

FIGS. 3A and 3B are flowcharts of a process for providing recommendations based on preloaded models, according to one embodiment;

FIG. 4 is a diagram of interactions utilized in the processes of FIG. 3, according to one embodiment;

FIGS. 5A-5B are diagrams of user interfaces utilized in the processes of FIG. 3, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for providing recommendations based on preloaded models are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

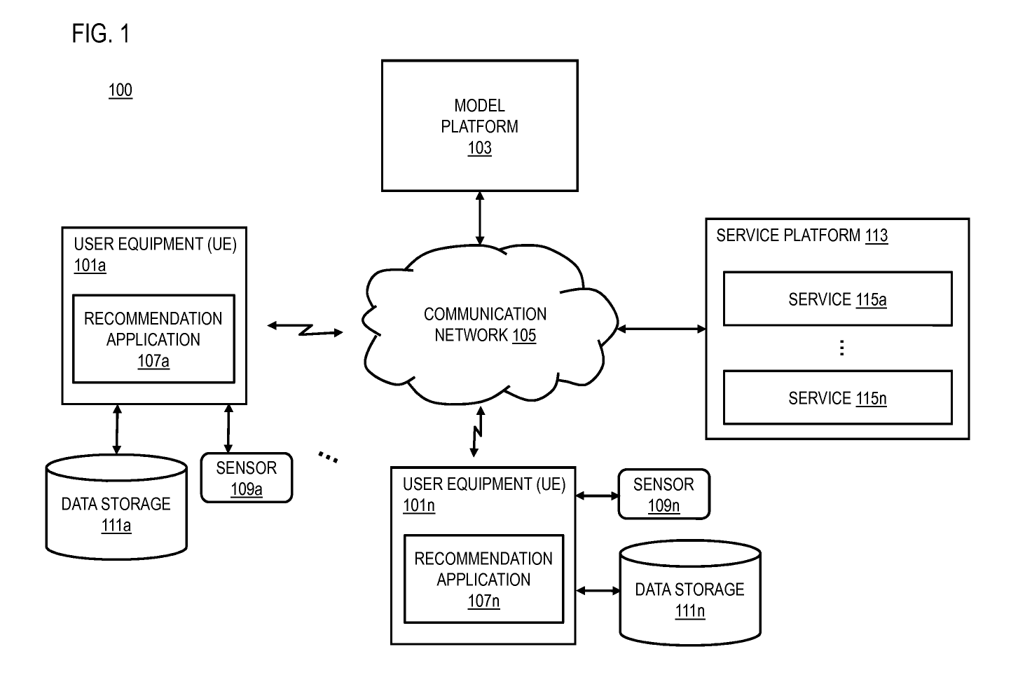

FIG. 1 is a diagram of a system capable of providing recommendations based on preloaded models, according to one embodiment. As previously discussed, personalization for a device and/or applications in the device according to the user has not been easily attained, although simple personalization may be performed. In particular, when there are many different users using the same application or the same type of applications, the applications cannot be personalized to the different users. In other words, user experience for a software application is generally the same for all users using their own respective devices, and the software application is not personalized for each user unless the user changes the settings for the application manually. There have been services provided for devices such that the services mine data from the devices and perform personalization based on the mined data for each of the devices. However, this may cause the services to mine personal data from a user's device that the user considers private or secret. Therefore, some users may not utilize this personalization approach by the services for privacy reasons. Further, because the data need to be transmitted to an entity outside of the user's device, the user's device may need more resources in network connection and may also drain more power or battery in the user's device. Therefore, a convenient approach to provide user personalization for the device and/or the device's applications while minimizing transmission of private user data to another device or a service is desired.

To address this problem, a system 100 of FIG. 1 introduces the capability to [INSERT TEXT]. According to one embodiment, the system 100 determines to cause preloading of a device (e.g. UE 101) with a user model and/or an item model. A user model includes information about the user's behavior, specificities, data captured by the user's device. The item model may be computed based on collected data corresponding to various items related to the user or the user's device. In this case, the items may represent various features or settings such as user interface modes, points of interest, etc. After preloading the device with the user model and/or the item model, the system 100 determines to cause processing of the user model and/or the item model to generate recommendations for the device and/or the user of the device. The recommendations may include recommendations of various features in the device. The features to be recommended may be items that include user interface modes, tips and points of interests, for example. The device may include various user interface modes having different features and/or designs, and the recommendations may be made for a suitable user interface based on the user model and/or the item model. The device may also include a library of tips (e.g. hints, tricks, etc) in using the device and/or applications in the device, and the tips may be presented based on the recommendations. Further, if the device contains a map, the recommendations may be made for points of interest based on the user model and/or the item model.

In one sample use case, a user study is performed first to generate user models and item models that can be preloaded to the user's device. This process to compute the user model may be performed on a plurality of devices that have been volunteered to become test devices. The test devices may collect various types of data regarding the test devices and/or the test user of the test devices. For example, the types of data may include data from sensors connected to the device, data on usage of the device, data on usage of external services by the device, the device's interaction with other devices and/or other services, etc. This data may be sent to a module or a platform that exists in a service or at least one of the devices. This data regarding the device and/or the user of the device is processed by a user model generation engine in the module to generate series of quantitative values associated with the information, wherein the quantitative values are passed to a function that returns a user model. The user model may be a vector, and a size of this vector may be n. This vector may include some or all of information of the quantitative values. Also, during the user study, the data regarding ratings on items may be collected. The items may represent features or characteristics of the user's device and/or the user, and may be included in the various types of the data collected in the test devices. For example, if an item is a tip on using the user's device, for each tip, the test user may place a rating. Then, the ratings data for this item is collected. Thus, each test user may have a series of ratings depending on the items. Using the user model and the user/item rating matrix, which represents the ratings data for the items, an item model may be computed.

This item model computed based on the user model and the ratings data may be preloaded to the user device, along with the user model generation engine. For example, during manufacturing of the user device, the item model and the user model generation engine may be preloaded to the user device. After a user first purchases the user device, during the first few days of use, the user device may collect various types of data regarding the device and/or the user of the user device, and compute the user's user model based on the collected data, using the user model generation engine. Then, based on the preloaded item model and the computed user's user model, ratings of the items may be estimated. The ratings of the items may be used to generate recommendations of the items. For example, if the ratings of the user interface indicate that a business user interface has the highest rating and a tourist user interface has a lower rating, the business user interface may be recommended.

As shown in FIG. 1, the system 100 comprises a user equipment (UE) 101 having connectivity to a model platform 103 via a communication network 105. Further, the UEs 101a-101n may have connectivity to one another via a communication network 105. The model platform 103 may be used to process a user model and/or an item model to generate recommendations for a device (e.g. UE 101) and/or a user of the device. The model platform 103 may also process a collection of data to generate the user model and/or the item model. The model platform 103 may exist in the UE 101 or in the service or independently. The UE 101 may include a recommendation application 107 that generates recommendations for the UE 101 based on a user model and/or an item model and/or any other information. The recommendation application 107 may also include a user model generation engine that is used to generate a user model based on the collected data. The UE 101 (e.g., UEs 101a-101n) may also be connected to the data storage connected to a sensor 109 (e.g., sensors 109a-109n), which is used to collect various types of sensor data for storage in, for instance, the data storage 111 (e.g., data storage 111a-111n). The sensor may include a location sensor such as a global positioning system (GPS) device, a sound sensor, a speed sensor, a brightness sensor, etc. The model platform 103 or the UE 101 itself may determine to cause collection of various types of data. The collected data may be related to items, a user of the UE 101, other users of other devices, or a combination thereof. The UE 101 may also have connectivity to a service platform 113 via the communication network 105. The service platform 113 may include one or more services 115a-115n. The services 115a-115n may be websites providing various services to the UE 101. Examples of the services 115a-115n may include a social networking service, an internet shopping service, a digital medial service, etc.

The model platform 103 may process the collection of the data collected at the UE 101 in order to generate a user model and/or an item model. The collected data may include user interaction data, ratings data, context data, or a combination thereof. The user interaction data includes data about how the user interacts with the UE 101. The user interaction data may also include the user's interaction with another device or external services such as the services 115a-115n. The ratings data may include user ratings of the items indicating how much the user likes the items (e.g. collected via like/dislike buttons for corresponding items). The context data may include the sensor data, user profile information, a user schedule, etc. Further, the user model may be a user profile vector and the item model may be an item profile vector. Thus, the user model and the item model may have quantitative values. When generating the user model and/or the item model, available data may be quantified to create the user profile vector and the item profile vector. Then, the generation of the recommendation is based on the user profile vector and/or the item profile vector.

In one embodiment, the system 100 may process the collection of the data prior to the preloading of the device with the user model and/or the item model. Further, in another embodiment, the collection of the data related to the other users may be processed to generate the user model and/or the item model, wherein the other users may represent prototypical users. These prototypical users may be test users that provide collections of data to generate test user models and/or test item models during a user study process. For example, a large number of test users may provide a large collection of data, such that the test user models and/or the test item models can be computed based on the collection of data. These test user models and/or test item models obtained during the user study process may be used to generate recommendations based on the data collected at the user device.

For example, prior to the preloading, the system 100 may collect the data from the devices of the users who have volunteered to be test users. The collected data from the test user devices may be processed to generate a user model having quantitative values, using a user model generation engine. As explained above, the collected data may include the user interaction data, the ratings data, the context data, etc. The user ratings data may be collected during this process by requesting the volunteers to assess the items with ratings such as a grade or a preference for the item. For example, one of the test users may assign 5 out of 10 rating for a business user interface and 2 out of 10 rating for a tourist user interface. As another example, one test user may indicate “like” rating for a tip on how to customize a calendar, and “dislike” rating for a tip on how to shut down the device. A combination of the user model and the item model for each item may result in a score that is related to the rating data. Thus, the item model may be computed for each item based on the user ratings and the user model. As a result, with the collected data from the volunteers, a test user model and a test item model may be computed.

In one embodiment where the user model is not preloaded at the UE 101, the system 100 determines user interaction data, ratings data, context data, or a combination thereof associated with the device and/or the at least one user of the device, and then processes this data to generate the user model. Thus, the UE 101 may generate the user model and/or the item model based on the data collected at the UE 101, if the user model is not preloaded at the UE 101. For example, when the test item model is preloaded at the UE 101, along with a user model generation engine, the UE 101 then starts collecting its own data such as user interaction data, ratings data, context data or a combination thereof. The collected data at the UE 101 can be processed to generate a user model for the UE 101 using the user generation engine. This user model for the UE 101 is then combined with the test item model, which then produces a score for the UE 101. This score for the UE 101 is related to predicted ratings of the items based on the user model derived from the collected data of the UE 101 and the test item model. In one embodiment, the items with high ratings may be recommended, while the items with low ratings are not recommended.

In an embodiment where the user model is preloaded at the UE 101, the system 100 determines user interaction data, ratings data, context data, or a combination thereof associated with the device and/or the at least one user of the device, and then processes this data to customize the at least one user model. For example, if the test user model is preloaded at the UE 101, the test user model may be customized based on the collected data at the UE 101 such that this user model can reflect the UE 101 or the user of the UE 101 more closely. In more detail, in this embodiment, a plurality of user models may be formed based on the data collected from a number of test users. Then, a plurality of user model-item model combinations may be formed. Each combination has different characteristics. When the device is preloaded with the user model and/or the item model during the manufacturing phase, the device may be preloaded with a set of the user models. As the user starts using the device, a random user model from the set may be selected. In one embodiment, a corresponding item model is also used. The selected user model and item model are first used to provide recommendations. Then, over a period of time, user feedback is monitored to dynamically build an evolving user model for the user of he device. This evolved user model may be used to select a user model-item model combination from the set of user models, such that the newly selected user model is closer to the evolved user model than the initially selected. This process may continue and may be performed periodically to select a user model that matches closely with the user.

Also, in one embodiment, the system 100 may cause a transfer of the user model and/or the item model from one device to another device associated with the user. For example, if the user using the UE 101a wants to start using the UE 101b, then the user may transfer the user model and/or the item model from the UE 101a to the UE 101b, such that the user model and/or the item model from the previous device UE 101a can be continued to be utilized in the new device UE 101b. In one embodiment, this transfer may be performed via an external service. For example, the UE 101a may transfer the user model and/or the item model to one of the services 115a-115n via the communication network 105, and the UE 101b may retrieve the transferred user model and/or item model from the one of the services 115a-115n.

Further, in one embodiment, the system 100 determines a new application, a new capability, a new item, new context data, or a combination thereof associated with the device and/or the user. Then, the system 100 causes an update to the user model and/or the item model, based on the new application, the new capability, the new item, the new context data, or a combination thereof. For example, if the UE 101 downloads new items or a new application having new items, then the user model and/or the item model is updated based on the new items or the new application. In addition, the system 100 may cause an update to the user model and/or the item model periodically, according to a schedule, on demand, or a combination thereof. This feature enables maintaining the user model and/or the item model that is up to date.

Therefore, an advantage of this approach is that by providing recommendations for the items while maintaining the user's data within the user device, it provides increased protection of privacy as well as conservation of resources in the user device. Because the user's data may be personal data, the user may want to keep the data within the user's device for protecting privacy. Because this approach preloads the user's device with a user model and/or an item model, the user does not need to transfer the user's data on usage and context data to a service, in order to obtain recommendations for the items. Further, because the data does not need to be transferred to the service to receive recommendations, the resources for transferring data are conserved. Therefore, means for providing recommendations based on preloaded models is anticipated.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof. It is contemplated that the communication network 105 may be operated in network mode (e.g., using traditional server-client architecture) or in ad-hoc mode (e.g., direct peer-to-peer connection of participating UEs 101).

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101 and the model platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

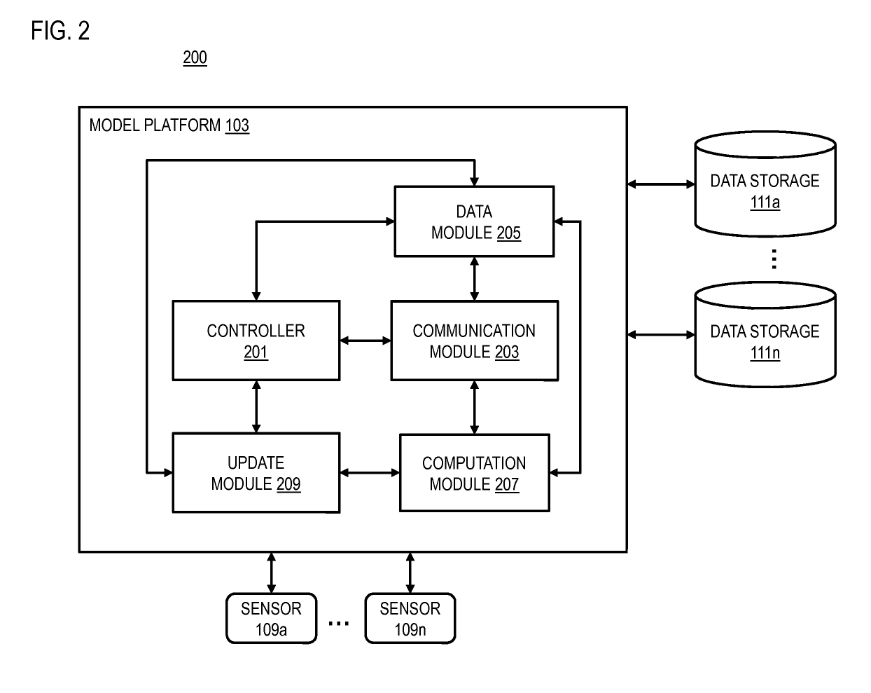

FIG. 2 is a diagram of the components of A, according to one embodiment. By way of example, the model platform 103 includes one or more components for providing recommendations based on preloaded models. It is contemplated that the functions of these components may be combined in one or more components or performed by other components of equivalent functionality. In this embodiment, the model platform 103 includes a controller 201, a communication module 203, a data module 205, a computation module 207 and an update module 209. The controller 201 oversees tasks, including tasks performed by the communication module 203, the data module 205, the computation module 207 and the update module 209 The communication module 203 is used for communication between the model platform 103 and one or more of the UE 101 and the service platform 113. The communication module 203 may be used to communicate commands, requests, data, etc. For example, the communication module 203 may be used to cause preloading of the device (e.g. UE 101) with a user model and/or an item model. The communication module 203 may also cause collection of the data. The data module 205 manages the collected data. The data module 205 may also communicate with the communication module 203 to receive and manage of collection of the data. The computation module 207 handles various analysis, estimations, computations, etc. For example, the computation module 207 may perform processing to generate recommendations for the device and/or the user of the device. The computation module 207 may also process the collection of data. The update module 209 may be used to determine updates to user model and/or the item model, and may also be used for any other tasks related to the updates to the device and/or the user of the device.

In one embodiment, the data module 205 may communicate with the communication module 203 to cause preloading of the device (e.g. UE 101) with the user model and/or the item model. Then, the computation module 207 may process or cause processing of the user model and the item model preloaded at the device, to generate recommendations for the device and/or the user of the device. The generation of the recommendation may be performed by the recommendation application 107 of the UE 101 and/or by the computation module 207. The recommendation may include recommendation of items.

The data module 205 may cause collection of data including user interaction data, ratings data, context data, or a combination thereof, wherein this data is related to items, a user of the device, other users, or a combination thereof. For example, the data module 205 may cause one or more of the UEs 101a-101n to collect the data. The user interaction data may include data about the user's interaction within the user device (internal usage) as well as data about the user's interaction with external devices or services (external usage). The ratings data may include ratings assigned for the items. For example, a user may be requested to provide ratings for the items, and the user's ratings of the items may be maintained as the ratings data. The context data may include sensor data collected from a sensor such as a location sensor, speed sensor, sound sensor, etc., as well as a calendar, user profile information and etc. The computation module 207 processes this collection to generate the user model and/or the item model.

The user model may be generated by a user model generation engine in the computation module 207, based on the collected data. The user model generation engine is capable of converting the collected data into a user model having quantitative values for the corresponding items. For example, the user model generation engine may be able to extract quantitative data such as the frequency of usage of each software application, the frequency of the user visiting a library (measured by the location sensor), a frequency of the user visiting the social networking website, etc. based on the collected data, and then generate the user model based on the quantitative data. Thus, the user model represents specificities of the user of the device. The user model may be combined with the item model to generate data that is related to the ratings data. Thus, the item model may be computed based on the user model and the ratings data. The user model may be a user profile vector (UPV) and the item model may be an item profile vector (IPV), wherein the generation of the recommendation is based on the user profile vector and/or the item profile vector. Then, a function of the UPV and the IPV, f(UPV, IPV), may generate a real number, which is associated with the ratings.

In one embodiment, the processing of this collection is performed prior to the preloading of the device with the user model and/or the item model. For example, the data may be collected from one or more of the UEs 101a-101n, and then may be processed to generate the user model and/or the item model. Then, the generated user model and/or the item model may be preloaded at the user device (e.g. one of the UEs 101a-101n). In another embodiment, the other users represent prototypical users. The prototypical users may be test users during a user study process to determine a test user model and a test item model. For example, a number of users may volunteer as the test users, and may agree to provide the data collected at their devices, wherein the data may include the user interaction data, ratings data, context data, or a combination thereof. The computation module 207 may process this data from the devices of the test users to generate the user model and the item model. As explained above, the user model and the item model may be the UPV and the IPV, respectively. In one example, in order to compute for an IPV for each item, the following objective function may be used according to a mean square error approach:

$${\sum }_{users} {( UPV \cdot IPV - Rating )}^{2} , \qquad ( 1 )$$

where f(UPV, IPV) is a dot product of the UPV and the IPV. The IPV is computed such that the equation (1) may produce the lowest possible number for the given UPV and the rating.

The item model computed based on the user model may be preloaded at the device (e.g. UE 101), along with the user model generation engine. The device may be a new device and the preloading may take place at a manufacturing stage. Thus, if the device does not have a user model preloaded, the device may capture its own data including interaction data, ratings data, context data, or a combination thereof, and then compute the user model based on this data. Then, the device may compute predicted ratings based on this user model and the preloaded item model, using the preloaded user model generation engine. The recommendations may be provided based on the computed ratings. In an example of a user interface mode as an item, if the computed rating for a business user interface mode is higher than the computed rating for a tourist user interface mode, the business user interface mode may be recommended.

In another embodiment, a user model may be preloaded in the user device along with the item model associated with the user model. In this embodiment, the device may determine its own data including interaction data, ratings data, context data, or a combination thereof, and then process this data to customize the user model. For example, a plurality of user models may be created based on the data collected from the test users, as well as item models associated with the user models. The device is first preloaded with a randomly selected user model and its associated item model. Over a period of time, the device may capture the data and process the data to dynamically evolve the user model. The evolved user model may then be compared with the plurality of the user models, and a new user model that matches the evolved user model may be selected and loaded at the device, along with its associated item model. This process may be repeated to continuously update the user model according to the data, in order to reflect the user.

Further, the update module 209 may determine a new application, a new capability, a new item, new context data, or a combination thereof associated with the device and/or the user. For example, a new application may be downloaded to the device, and this new application may have new items and/or enable acquisition of new context data, or a new update for the device may be provided to the device such that the device has a new capability. Then, the update module 209 may cause update to the user model and/or the item model based on the new application, the new capability, the new item, the new context data, or the combination thereof. In addition, the update module 209 may cause update to the user model and/or the item model periodically (e.g. weekly, monthly, etc), according to a schedule, on demand, or a combination thereof.

In addition, a user may want to switch from one device to another device, but wants to maintain the user model and/or the item model. The communication module 203 may cause a transfer of the user model and/or the item model from the first device to the second device associated with the user. This transfer may also be performed via an external service. For example, the communication module 203 may cause a transfer of the user model and/or the item model from the first device to an external service. Then, the user model and/or the item model in the external service can be downloaded to the second device.

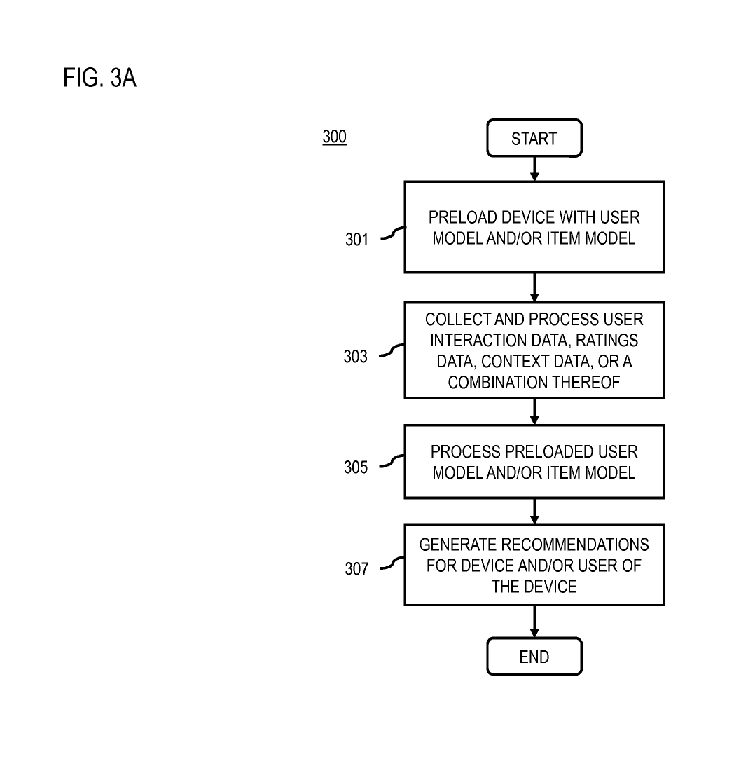

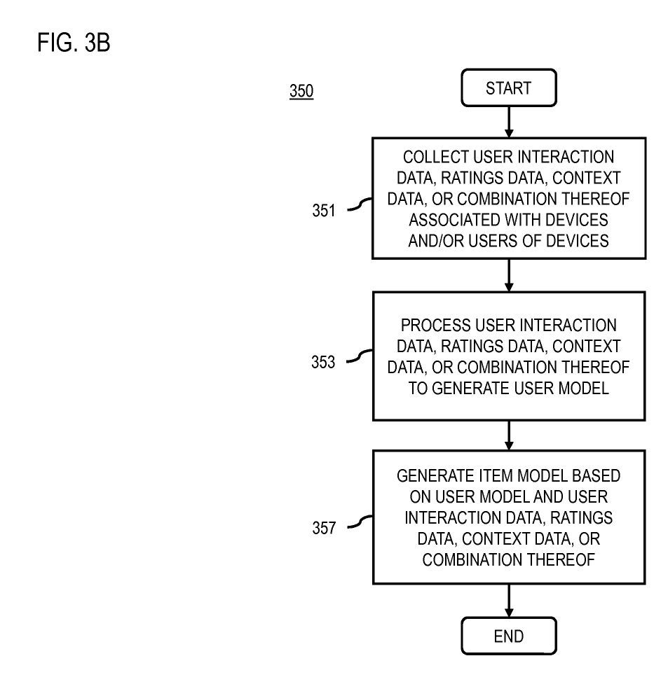

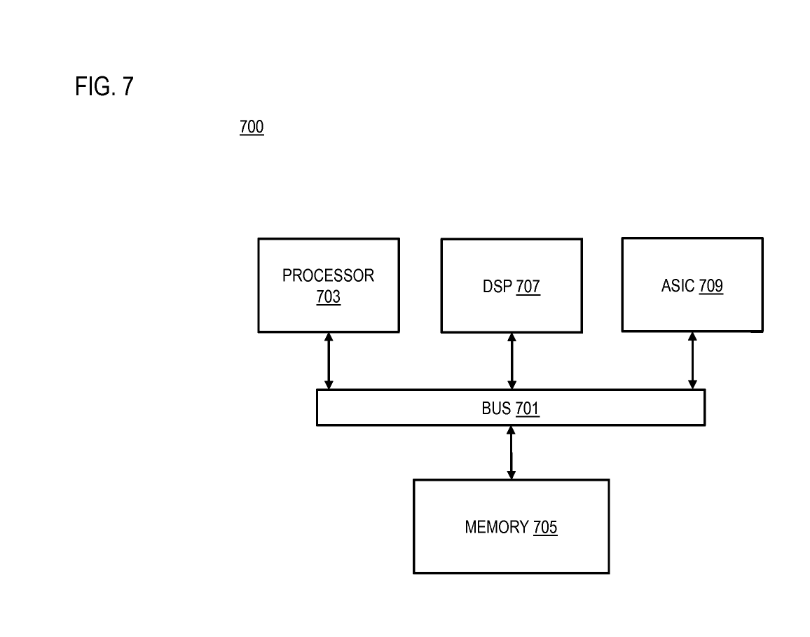

FIGS. 3A-3B are flowcharts of a process for providing recommendations based on preloaded models, according to one embodiment. FIG. 3A shows a process 300 for generating recommendations at a device that is preloaded with a user model and/or an item model. In one embodiment, the model platform 103 performs the process 300 and is implemented in, for instance, a chip set including a processor and a memory as shown in FIG. 7. In step 301, the model platform 103 causes preloading of the device (e.g. UE 101) with a user model and/or an item model. A user model may be quantitative data representing user specificities related to the items. Items may represent various features or settings, such as user interface modes, points of interest, useful tips and hints, etc. There may be ratings for the items, wherein the ratings are quantitative values. In one example, higher rating represents higher preference. The user model and the item model can be combined together to generate ratings or data related to ratings. Thus, if the user model and ratings data for the items are known, the item model may also be calculated based on the user model and the ratings data. In one embodiment, the user model and the item model are vectors, which may be a user profile vector (UPV) and an item profile vector (PV), respectively. Further, the preloading may take place at a manufacturing stage of the device, before the device is delivered to the user. The user model and/or the item model that is preloaded at the device may be standard user model and/or the item model that are trained or created based on information about a large number of users.

In step 303, the model platform 103 causes collection of user interaction data, ratings data, context data, or a combination thereof, from the device. The user interaction data may include the user's internal usage data and the user's external usage data. The user's internal usage data may include data regarding the user's interaction within the device. This may include the user's usage of software applications (e.g. telephone, text messages, email application, a calendar, a media player, advertisements clicked), as well as the time and the location when the use took place. The external usage data may include data regarding the user's interaction with an external service or another device. For example, the user's usage of a picture sharing website (e.g. downloading and uploading pictures at the website) or the user's usage of a social networking service may be recorded as the external usage data. The ratings data may represent ratings of the items. The ratings data may be collected by requesting the user to participate in the rating. The rating may be in a number scale (e.g. a scale of one through ten) or in a like/dislike button format. The context data may include data from a sensor such as a location sensor, a speed sensor, an audio sensor, a brightness sensor, etc. The context data may also include user profile information as well as the user calendar information. The user interaction data and the context data may be used to form the user model.

Also in step 303, this data collected at the device (e.g. UE 101) may be processed to generate a user model for the device. If the item model is preloaded at the device but the user model is not preloaded, then the model platform 103 may determine user interaction data, ratings data, the context data or a combination thereof associated with the device, and process this data to generate the user model. In another embodiment, if the user model is preloaded at the device or the user model already exists in the device, then this data may be processed to customize the existing user model. In one example, a plurality of user models may be available for the preloading, as well as their item models, and one user model may be randomly selected and may be preloaded at the device. Over a period of time, the device collects the data, and customizes the initially selected user model based on the collected data. This customized user model may be compared with other user models from the set of the plurality of user models, and then a user model that matches the customized user model closely may be loaded at the device. This process may be repeated to provide the most up-to-date user model for the user.

Then, in step 305, the model platform 103 causes processing of the preloaded user model and/or item model, and then in step 307 the model platform 103 causes generation of recommendations for the device and/or the user of the device. In this step, because the user model and the item model may be combined to result ratings data, the user model and the item model may be processed to create the ratings data. The ratings data may be used to generate recommendations. The items showing high ratings are generally recommended. Thus, for example, if a tourist's points of interest show high ratings while a professor's points of interest show low ratings, a map on the device may display the tourist's points of interest, showing popular tourist destinations on the map.

In one embodiment, the model platform 103 may determine a new application, a new capability, a new item, new context data, or a combination thereof, associated with the device and/or the user, and then may cause an update to the user model and/or the item model, based on this information. For example, if the device downloads a new application or update the device software for new capability and new items, or a new context data is available at the device, then the existing user model and/or item model may not reflect these new features. Therefore, it may be helpful to update the user model and/or the item model according to these new features. The update to the user model and/or the item model may be performed periodically, according to a schedule, on demand, or a combination thereof.

In another embodiment, the model platform 103 causes a transfer of the user model and/or the item model to another device associated with the user. This may be performed if the user wants to maintain the same user experience by keeping the same user model and/or item model when switching to another device. This transfer may also be performed via an external service. For example, the user model and/or the item model may first be transferred from the originating device to the service, and then can be downloaded to another device from the service.

FIG. 3B shows a process 350 of generating an item model and a user model during a user study process. In one embodiment, the model platform 103 performs the process 350 and is implemented in, for instance, a chip set including a processor and a memory as shown in FIG. 7. Prior to preloading the device with the user model and/or the item model, a user study may be performed on a number of users, in order to create a user model and/or an item model that represent a large number of users. In step 351, the model platform 103 causes collection of user interaction data, ratings data, context data, or a combination thereof associated with devices and/or users of the devices. A large number of users may be solicited to volunteer as users providing this information. In step 353, the model platform 103 causes processing of the user interaction data, the ratings data, the context data, or a combination thereof, to generate a user model. Therefore, the user model is generated for the collected data associated with the devices and/or users of the devices. This collection of the data may be performed at the respective user devices first, and then later transferred to a centralized server that generates the user model. Alternatively, the collected data may be used to generate user models at the respective devices, and then the generated user models may be sent to the centralized server for further analysis.

Then, in step 357, the model platform 103 causes generation of an item model based on the user model and the user interaction data, the ratings data, the context data, or the combination thereof, associated with the devices and/or the users of the devices. In one embodiment, because the user model and the item model may be combined to result ratings data, the item model may be derived based on the user model computed based on this data and the ratings data. The user model and/or the item model generated during this user study process may be preloaded at a device, as explained above in FIG. 3A.

This process is advantageous in that it provides a convenient way to provide recommendations for the items based on the collected data, without sending the collected data outside the user's device. The model platform 103 is a means for achieving this advantage.

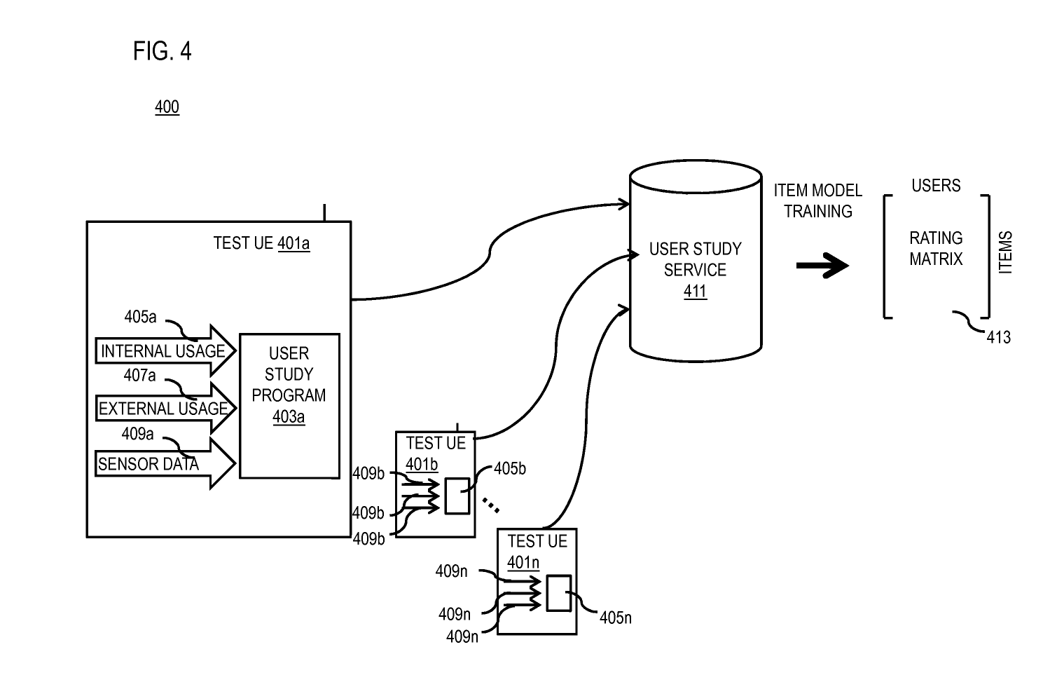

FIG. 4 is a diagram of interactions utilized in the processes of FIG. 3, according to one embodiment. This diagram 400 shows how the user model and the item model are generated such that the item model can be pre-loaded to a user device. This may take place during a user study when data is collected from devices of prototypical users or test users. The test UEs 401a-401n may use a user study program application 403a-403n to collect data including the internal usage data 405a405n, the external usage data 407a-407n and the sensor data 409a-409n, respectively. The internal usage data, the external usage data, and the sensor data may include information about the items that can be offered to the user. The internal usage data may include data showing which software applications are used, and when and where the applications are used. The external usage data may include data regarding usage of devices or services outside the device, and thus may include usage of internet services (e.g. browsing social networking site, downloading music from media download site etc). The sensor data may include data collected via a sensor connected to the test UE 401, wherein the sensors may include a location sensor (e.g. GPS), accelerometer, gyroscope/compass, audio sensor), and may also include context data based on the sensors, such as staying at home or at office (determined based on the location device, for example. The data collected at the test UEs 401a-401n may be sent to the user study service 411 such that the user study service 411 may compute the user models. The user models may be vectors with quantitative values. Alternatively, the user models may be computed at the respective test UEs 401a-401n based on their respective data, and then may be sent to the user study service 411. The user study service 411 may also collect ratings data from the test UEs 401a-401n corresponding to the items. Then, based on the computed user models and the ratings data for the items, an item model is computed. Because the ratings data 413 is based on a combination of the item model and the user model, the item model may be computed based on the user model of the test users and their ratings data. The user model and/or the item model then can be preloaded to a user device, when the user first starts using the user device. Then, the user device may collect its own data, determine its own user model, and then using this item model 413, derive predicted ratings for the items at the user device, in one embodiment.

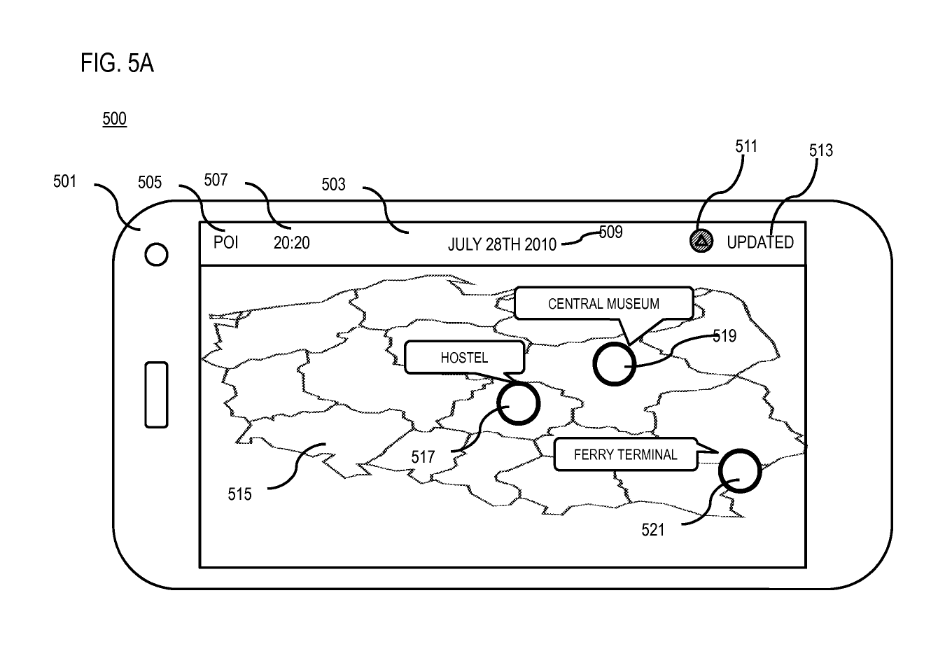

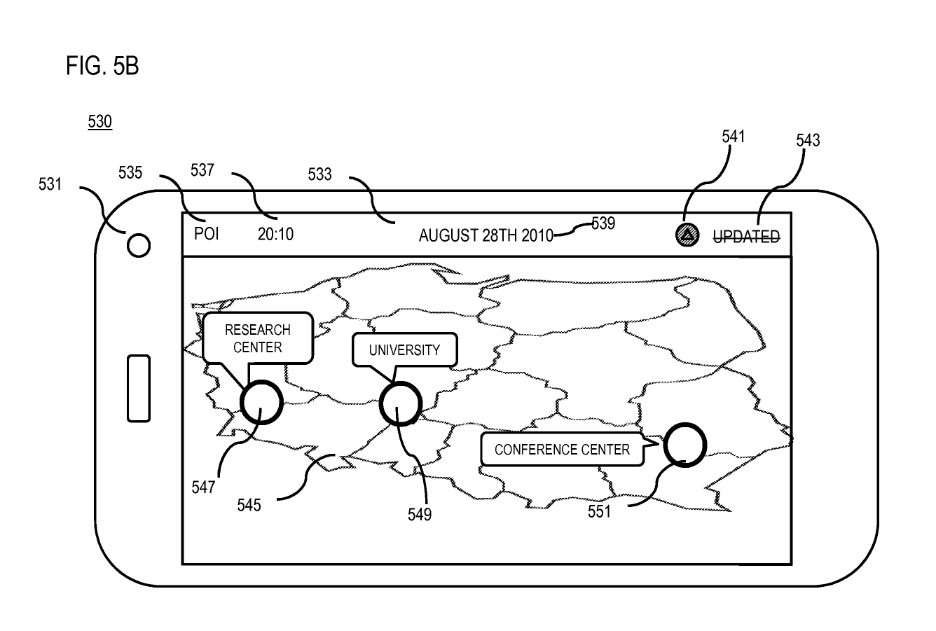

FIGS. 5A-5B are diagrams of user interfaces utilized in the processes of FIG. 3, according to various embodiments. FIG. 5A shows a user interface 500 of a mobile device 501, wherein the user model and the ratings indicate that the user of this device 501 is likely to be a tourist. The title bar 503 shows an item indicator 505, which indicates that the item shown in the user interface 500 is the point of interest “POI.” The title bar 503 also shows a current time 507, and a current date 509. The title bar also has an item model indicator 511 indicating whether an item model has been preloaded to the mobile device 501 shows that an item model has been preloaded, as shown by a gray fill in the item model indicator 511. The update sign 513 indicates that the user model has been updated. The main screen 515 shows a map of the surrounding area where the mobile device 501 is located. As the user of this device 501 is likely to be a tourist, this user has high ratings for tourist destinations, wherein the ratings are estimated based on the preloaded item model and the user model generated based on the data collected at the mobile device 501. Hence, the main screen 515 recommends tourist destinations as points of interests, such as the hostel 517, the central museum 519 and the ferry terminal 521.

FIG. 5B shows a similar user interface 530 of a mobile device 531 to the user interface 500 of FIG. 5A. In FIG. 5B, the user model and the ratings indicate that the user of this device 531 is likely to be a professor. The title bar 533 shows an item indicator 535, which indicates that the item shown in the user interface 530 is the point of interest “POI.” The title bar 533 also shows a current time 537, and a current date 539. The title bar also has an item model indicator 541 indicating whether an item model has been preloaded to the mobile device 531 shows that an item model has been preloaded, as shown by a gray fill in the item model indicator 541. The update sign 543 indicates that the user model has NOT been updated, as indicated by the strike-through line on the word “updated.” The main screen 545 shows a map of the surrounding area where the mobile device 531 is located. In this example, the user of the device 531 is likely to be a professor, and thus this user has high ratings for destinations for a professor. The ratings are estimated based on the preloaded item model and the user model generated based on the data collected at the mobile device 531. Therefore, the main screen 545 recommends destinations that professors frequent as points of interest, such as the research center 547, the university 549 and the conference center 551.

The processes described herein for providing recommendations based on preloaded models may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

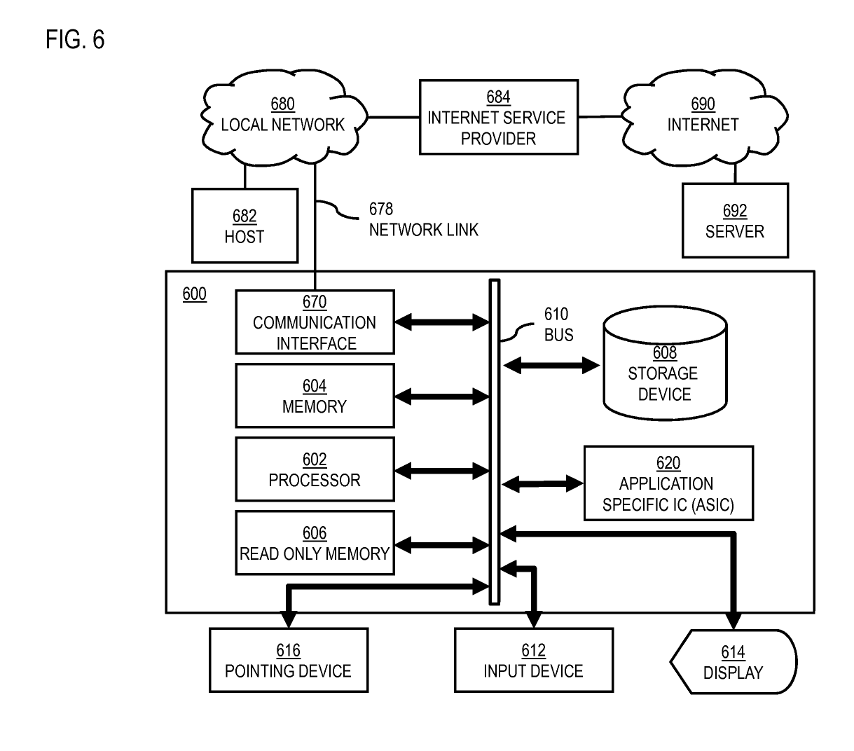

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to provide recommendations based on preloaded models as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of providing recommendations based on preloaded models.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to providing recommendations based on preloaded models. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for providing recommendations based on preloaded models. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing recommendations based on preloaded models, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for providing recommendations based on preloaded models.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to provide recommendations based on preloaded models as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of providing recommendations based on preloaded models.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide recommendations based on preloaded models. The memory 705 also stores the data associated with or generated by the execution of the inventive steps.

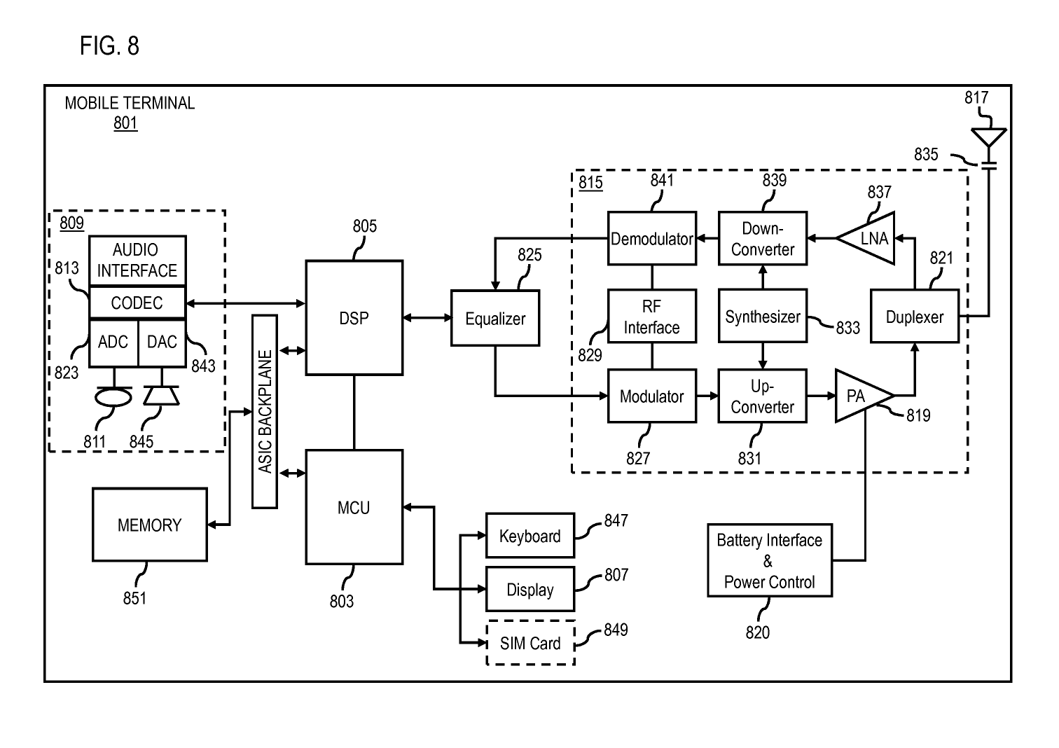

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of providing recommendations based on preloaded models. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of providing recommendations based on preloaded models. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to provide recommendations based on preloaded models. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination to cause, at least in part, preloading of a device with at least one user model, at least one item model, or a combination thereof; and
a processing of the at least one user model, the at least one item model, or a combination thereof to generate at least one recommendation for: (a) the device, (b) at least one user of the device, or (c) a combination thereof.

2. A method of claim 1, wherein the (1) data and/or (2) information and/or (3) at least one signal are further based, at least in part, on the following:
a collection of user interaction data, ratings data, context data, or a combination thereof related to: (a) one or more items, (b) the at least one user, (c) one or more other users, or (d) a combination thereof; and
a processing of the collection to generate the at least one user model, the at least one item model, or a combination thereof.

3. A method of claim 2, wherein the processing of the collection is performed prior to the preloading of the device with the at least one user model, the at least one item model, or a combination thereof.

4. A method of claim 2, wherein the one or more other users represent, at least in part, one or more prototypical users.

5. A method of claim 1, wherein the at least one user model is not preloaded at the device, and wherein the (1) data and/or (2) information and/or (3) at least one signal are further based, at least in part, on the following:
user interaction data, ratings data, context data, or a combination thereof associated with the device, the at least one user of the device, or a combination thereof; and
a processing of the user interaction data, the ratings data, the context data, or a combination thereof to generate the at least one user model.

6. A method of claim 1, wherein the at least one user model is preloaded at the device, and wherein the (1) data and/or (2) information and/or (3) at least one signal are further based, at least in part, on the following:
user interaction data, ratings data, context data, or a combination thereof associated with the device, the at least one user of the device, or a combination thereof; and
a processing of the user interaction data, the ratings data, the context data, or a combination thereof to customize the at least one user model.

7. A method of claim 1, wherein the at least one user model is at least one user profile vector and the at least one item model is at least one item profile vector, and wherein the generation of the at least one recommendation is based, at least in part, on the least one user profile vector, the at least one item profile vector, or a combination thereof.

8. A method of claim 1, wherein the (1) data and/or (2) information and/or (3) at least one signal are further based, at least in part, on the following:
at least one new application, at least one new capability, at least one new item, new context data, or a combination thereof associated with the device, the at least one user, or a combination thereof; and
at least one determination to update the at least one user model, the at least one item model, or a combination thereof based, at least in part, on the at least one new application, the at least one new capability, the at least one new item, the new context data, or a combination thereof.

9. A method of claim 1, wherein the (1) data and/or (2) information and/or (3) at least one signal are further based, at least in part, on the following:
at least one determination to update the at least one user model, the at least one item model, or a combination thereof periodically, according to a schedule, on demand, or a combination thereof.

10. A method of claim 1, wherein the (1) data and/or (2) information and/or (3) at least one signal are further based, at least in part, on the following:
at least one determination to initiate a transfer of the at least one user model to at least another device associated with the at least one user.

11. A method of claim 10, wherein the transfer is via an external service.

12. An apparatus comprising:
at least one processor; and
at least one memory including computer program code for one or more programs,
the at least one memory and the computer program code configured to, with the at least one processor, cause the apparatus to perform at least the following,
determine to cause, at least in part, preloading of a device with at least one user model, at least one item model, or a combination thereof; and
process and/or facilitate a processing of the at least one user model, the at least one item model, or a combination thereof to generate at least one recommendation for: (a) the device, (b) at least one user of the device, or (c) a combination thereof.

13. An apparatus of claim 12, wherein the apparatus is further caused to:
determine to cause, at least in part, collection of user interaction data, ratings data, context data, or a combination thereof related to: (a) one or more items, (b) the at least one user, (c) one or more other users, or (d) a combination thereof; and
process and/or facilitate a processing of the collection to generate the at least one user model, the at least one item model, or a combination thereof.

14. An apparatus of claim 13, wherein the processing of the collection is performed prior to the preloading of the device with the at least one user model, the at least one item model, or a combination thereof.

15. An apparatus of claim 12, wherein the at least one user model is not preloaded at the device, and wherein the apparatus is further caused to:
determine, at least in part, user interaction data, ratings data, context data, or a combination thereof associated with the device, the at least one user of the device, or a combination thereof; and
process and/or facilitate a processing of the user interaction data, the ratings data, the context data, or a combination thereof to generate the at least one user model.

16. An apparatus of claim 12, wherein the at least one user model is preloaded at the device, wherein the apparatus is further caused to:
determine, at least in part, user interaction data, ratings data, context data, or a combination thereof associated with the device, the at least one user of the device, or a combination thereof; and
process and/or facilitate a processing of the user interaction data, the ratings data, the context data, or a combination thereof to customize the at least one user model.

17. An apparatus of claim 12, wherein the apparatus is further caused to:
determine at least one new application, at least one new capability, at least one new item, new context data, or a combination thereof associated with the device, the at least one user, or a combination thereof; and
determine to update the at least one user model, the at least one item model, or a combination thereof based, at least in part, on the at least one new application, the at least one new capability, the at least one new item, the new context data, or a combination thereof.

18. An apparatus of claim 12, wherein the apparatus is further caused to:
determine to update the at least one user model, the at least one item model, or a combination thereof periodically, according to a schedule, on demand, or a combination thereof.

19. A computer-readable storage medium carrying one or more sequences of one or more instructions which, when executed by one or more processors, cause an apparatus to at least perform the following steps:
determining to cause, at least in part, preloading of a device with at least one user model, at least one item model, or a combination thereof; and
process and/or facilitate a processing of the at least one user model, the at least one item model, or a combination thereof to generate at least one recommendation for: (a) the device, (b) at least one user of the device, or (c) a combination thereof.

20. A computer-readable storage medium of claim 6, wherein the apparatus is caused to further perform:
determining to cause, at least in part, collection of user interaction data, ratings data, context data, or a combination thereof related to one or more items, the at least one user, one or more other users, or a combination thereof; and
process and/or facilitate a processing of the collection to generate the at least one user model, the at least one item model, or a combination thereof.

21.-51. (canceled)
